(19) United States
(12) Patent Application Publication
(10) Pub. No.: US 2025/0304477 A1
(43) Pub. Date: Oct. 2, 2025

(54) AN AQUEOUS FLUID REACTOR AND A METHOD OF CARRYING OUT WATER OXIDATION AND/OR WATER GASIFICATION

(71) Applicant: AQUARDEN TECHNOLOGIES APS, Skævinge (DK)

(72) Inventor: Zhuoyan CAI, Skævinge (DK)

(21) Appl. No.: 18/864,074

(22) PCT Filed: May 12, 2023
(86) PCT No.: PCT/EP2023/062764

§ 371 Date: Nov. 8, 2024

(30) Foreign Application Priority Data
May 12, 2022 (EP) 22173039.3
Jun. 10, 2022 (DK) PA202270310

(51) Int. Cl. C02F 1/72

(52) U.S. Cl. CPC C02F 1/72; C02F 2209/02; C02F 2209/03; C02F 2209/40; C02F 2301/066

(57) ABSTRACT

Preferred embodiments of the invention relate to aqueous fluid oxidation reactor adapted to contain inside the reactor an aqueous fluid at elevated pressure and temperature during which an oxidation occurs, said fluid comprising organic and/or inorganic material. The reactor preferably comprises an enclosure dividing5 a cavity inside the reactor cavity into an inner cavity inside the enclosure and an outer cavity outside the enclosure. Preferred embodiments also relate to carrying out water oxidation by use of a reactor according to the invention.

Preferred embodiments of the invention relate to aqueous fluid oxidation reactor adapted to contain inside the reactor an aqueous fluid at elevated pressure and temperature during which an oxidation occurs, said fluid comprising organic and/or inorganic material. The reactor preferably comprises an enclosure dividing a cavity inside the reactor cavity into an inner cavity inside the enclosure and an outer cavity outside the enclosure. Preferred embodiments also relate to carrying out water oxidation by use of a reactor according to the invention.

### BACKGROUND OF THE INVENTION

Some wastewater contains undesirable pollutants in terms of organic and/or inorganic materials which represents an environmental hazard if released to the environment. Such materials may become less hazardous or fully destroyed if oxidised.

Oxidation of organic and/or inorganic materials in aqueous fluid at elevated pressure and temperature has proven to an efficient way to carry out such oxidation. In such processes, an aqueous fluid containing the materials to be oxidised is introduced into a cavity typically together with an oxidizing agent in which the prevailing elevated pressure and temperature accelerates the oxidation process.

While such a process represents an efficient way of oxidising there are a number of technical problems related to providing a reactor which can be produced and used at financial attractive costs and being easy to maintain and operate.

Some of the problems related to providing a reactor suitable for oxidation is that the pressure and/or temperature inside the reactor may be at supercritical conditions (water) and the fluid during the oxidization or oxidation by-products are often highly corrosive requiring special attention to the choice of material from which the reactor is manufactured.

### OBJECT OF THE INVENTION

An object of the invention may be to provide a reactor which reduces the production or maintenance costs. Another object of the invention relates to providing inline monitoring of corrosion levels of the reactor wall.

An object of the invention may be to provide a reactor for which problems related to servicing the reactor are at least mitigated.

### SUMMARY OF THE INVENTION

The invention relates in a first aspect to an aqueous fluid reactor, preferably being an aqueous fluid oxidation reactor and/or aqueous fluid gasification reactor, adapted to contain inside the reactor an aqueous fluid at elevated pressure and temperature, preferably during which an oxidation and/or a gasification occur(s), said fluid comprising organic and/or inorganic material, wherein the reactor preferably comprises
a reactor body in the form of an elongate tubular element arranged, during use, with its longitudinal extension parallel to or substantially parallel to gravity, the reactor body being closed at its upper and lower ends thereby defining a reactor cavity inside the reactor body;
an enclosure extending from said lower end toward said upper end, said enclosure divides the reactor cavity into an inner cavity inside the enclosure and an outer cavity outside the enclosure,
a flush fluid connection extending from the outer cavity and into the inner cavity from a position at an upper end of said enclosure and to first vertical height, said vertical height being larger than zero;
a flush fluid inlet arranged to feed flush fluid into the outer cavity,
a treated fluid output connection having an inlet arranged at a second vertical height inside said inner cavity, and having an outlet arranged at the outside of the reactor body, said second vertical height preferably being larger than said first vertical height and said treated fluid output connection extends from its inlet downwardly towards the lower end of the reactor;
an aqueous fluid inlet connection(s) arranged at the lower end of the reactor body for inletting into the inner cavity the aqueous fluid, and preferably an oxidizing agent, to be brought into an elevated pressure and temperature.

In another aspect, the invention relates to aqueous fluid reactor, preferably being an aqueous fluid oxidation and/or aqueous fluid gasification reactor, adapted to contain inside the reactor an aqueous fluid at elevated pressure and temperature, preferably during which an oxidation and/or gasification occur(s), said fluid comprising organic and/or inorganic material, wherein the reactor comprising
a reactor body in the form of an elongate tubular element arranged, during use, with its longitudinal extension parallel to or substantially parallel to gravity, the reactor body being closed at its upper and lower ends thereby defining a reactor cavity inside the reactor body;
an enclosure extending from said lower end toward said upper end, said enclosure divides the reactor cavity into an inner cavity inside the enclosure and an outer cavity outside the enclosure,
a flush fluid inlet arranged to feed flush fluid into the outer cavity,
a flush fluid connection extending
   downwardly from the outer cavity and into the inner cavity from a position at an upper end of said enclosure and to first vertical height, said vertical height being larger than zero and/or
   upwardly from a bottom of said reactor and into the inner cavity and being fluidicly connected to said flush fluid inlet to feed flush fluid into said flush fluid connection;
a treated fluid output connection having an inlet arranged at a second vertical height inside said inner cavity, and having an outlet arranged at the outside of the reactor body, said second vertical height being larger than said first vertical height and said treated fluid output connection extends from its inlet downwardly towards the lower end of the reactor;
an aqueous fluid inlet connection arranged at the lower end of the reactor body for inletting into the inner cavity (5) the aqueous fluid, and preferably an oxidizing agent, to be brought into an elevated pressure and temperature.

In preferred embodiment internal fluid communication, if present, between the inner cavity and the outer cavity is provided through the flush fluid connection, and preferably only through the flush fluid connection.

Terms used herein are used in manner being ordinary to a skilled person. Some of the used terms are detailed here below:

Treated fluid as used herein is used in a broad meaning to include a treated fluid produced by water oxidation process where the resulting fluid from an oxidation process is carried out according to the present invention.

“Water oxidation” or “water oxidation process” are preferably used to reference one or more chemical oxidation processes taking place in an aqueous fluid inlet to the reactor, e.g. oxidise organic contaminants and/or inorganic components in general.

In a second aspect, the invention relates to a method of carrying out water oxidation, the method utilizes a reactor according to the first aspect claims and may comprise
introducing an aqueous fluid containing organic and/or inorganic material to be oxidized and preferably mixed with an oxidizing agent into the inner cavity through the aqueous fluid inlet connection,
preferably, introducing a flush fluid, preferably water such as demineralized water, into the outer cavity through the flush fluid inlet,
maintaining a pressure and a temperature inside the inner cavity sufficient to facilitate at least some oxidation of said organic and/or inorganic material, wherein said maintaining of said pressure is provided by controlling a flow rate of aqueous fluid in combination with controlling the back pressure at the treated fluid output connection.

### BRIEF DESCRIPTION OF THE FIGURES

The present invention and in particular preferred embodiments thereof will now be described in more details with regards to the accompanying figures. The figures show ways of implementing the present invention and are not to be construed as being limiting to other possible embodiments falling within the scope of the attached claim set.

FIG. 1 schematically illustrates a first embodiment of an aqueous fluid oxidation reactor in a cross sectional view;

FIG. 2 schematically illustrates the reactor of first embodiment in a 3-dimensionally exploded and simplified view where some features are left out for clarity reasons and top-members and bottom-member shown distanced from an elongate tubular wall section. Kindly observe that FIG. 2 has been drawn not to disclose thickness of the various parts;

FIG. 3 schematically illustrates another embodiment of an aqueous fluid oxidation reactor in a cross-sectional view;

FIG. 4 schematically illustrating a further embodiment of an aqueous fluid oxidation reactor in a cross-sectional view.

### DETAILED DESCRIPTION OF PREFERRED EMBODIMENTS

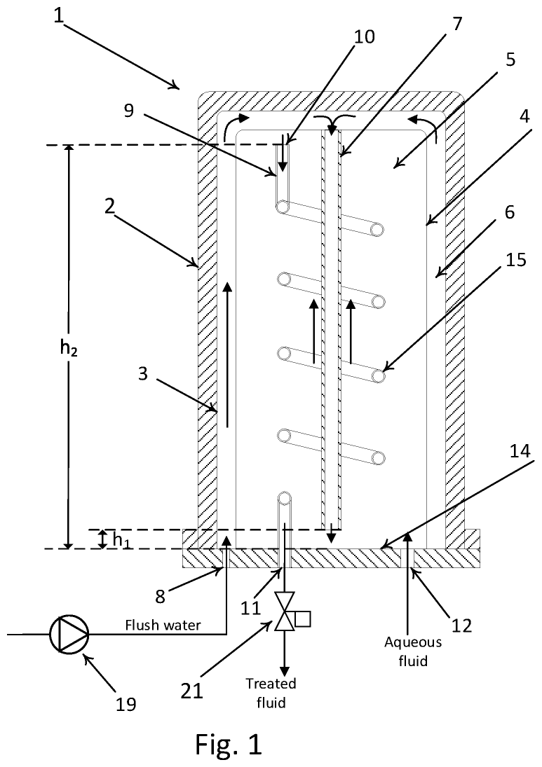

Reference is made to FIG. 1 schematically illustrating in cross sectional view an aqueous fluid oxidation reactor 1. The reactor 1 is used to oxidise organic contaminants in an aqueous fluid, which in many cases is water containing one or more contaminants which can be oxidised thereby cleaning the water. However, the reactor may also be used to oxidise other aqueous fluids. The oxidation is carried out at a pressure level and temperature level being elevated relative to atmospheric conditions (1 bar and 20° C.). In some embodiments, the oxidation is carried out in subcritical phase and/or in supercritical phase, albeit typically at supercritical pressures. Embodiments in which a lower section of the reactor is at subcritical conditions and an upper section of the reactor is at supercritical condition are also considered to be within the scope of the present invention.

Thus, reactor 1 is adapted to contain inside the reactor 1 an aqueous fluid at elevated pressure and temperature during which an oxidation occurs and the aqueous fluid may comprise organic and/or inorganic material to be oxidised.

In other embodiments, the reactor is used for gasification of an aqueous fluid comprising organic and/or inorganic material, and in such embodiments reactor 1 is adapted to contain inside the reactor 1 an aqueous fluid at elevated pressure and temperature during which a gasification occurs.

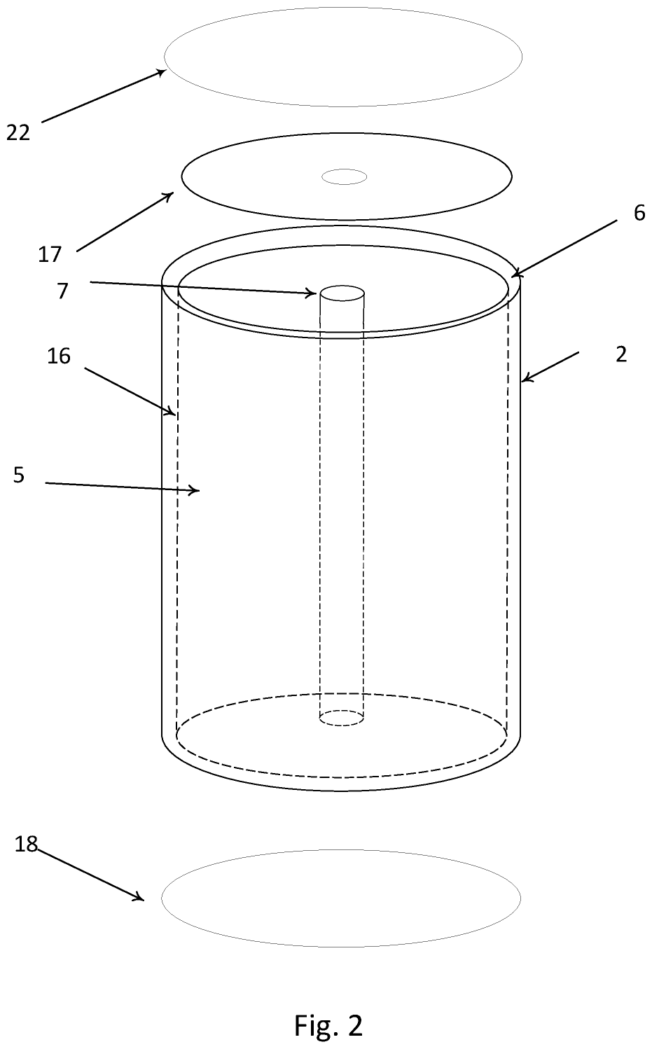

As shown in FIG. 1, the reactor comprises a reactor body 2 in the form of an elongate tubular element 2 (see FIG. 2 for more details). It is to be emphasised that tubular element does not imply cylindrical, although this shape may be preferred, as other shapes than cylindrical may be chosen as a shape for the tubular element 2.

This tubular element 2 is arranged, during use of the reactor 1, with its longitudinal extension parallel to or substantially parallel to gravity, and the reactor body 2 being closed at its upper and lower ends thereby defining a reactor cavity 3 inside the reactor body 2. As presented in FIG. 2, the reactor body 2 may be closed by specific closing members 18 and 22, but the reactor body may not need to be made up by such separate elements.

The reactor also comprises an enclosure 4 extending from said lower end toward said upper end. This enclosure 4 is a physical element typically made from a material having a thickness. The enclosure is a tubular element which may be cylindrical, but other shapes are also considered to be within the scope of the invention. As shown in FIG. 1, the enclosure 4 divides the reactor cavity 3 into an inner cavity 5 inside the enclosure 4 and an outer cavity 6 outside the enclosure 4. As also apparent from FIG. 1, the enclosure 4 is shaped so that fluid can flow between the outer cavity 6 and inner cavity 5 through an opening provided at the upper end of the enclosure. Accordingly, the enclosure 4 may also be disclosed as a tubular element being closed at a lower end—typically by being sealed internally to a lower end of the reactor body 2—and comprising an upper wall member comprising an opening.

Preferred embodiments of the invention aim at that the water oxidation will mainly, such as essentially only, take place in the inner cavity 5. This is in preferred embodiments accomplished by providing a flow of flush water into the cavity 5 through the flush fluid connection 7. By this flow of flush water into the inner cavity 5, transport of salts and/or other chemical compounds from the inner cavity 5 into the outer 6 is essentially prevented. This will be further detailed below.

Accordingly, a flush fluid connection 7 is provided which extends from the outer cavity 6 and into the inner cavity 5, typically from a position at an upper end of said enclosure 4 and to a first vertical height h₁ (larger than zero). The flush connection 7 is used to introduce a fluid into the inner cavity 5 at a lower region of the inner cavity 5 to prevent salts and/or other debris, sediments or the like which may accumulate in the inner cavity during oxidation of the aqueous fluid from coming into direct contact with reactor body 2. The first vertical height h₁ is provided to provide a flow clearance between the lower end of the flush fluid connection 7 and the interior bottom of the reactor body 2. As will be further detailed below, the inner volume of the flush fluid connection 7 may be seen as a buffer volume which in case the pressure state in the reactor would provide a flow of water from the inner cavity 6 towards the outer cavity 5. If this occurs, the fluid flowing into the outer cavity 6 will—at least for some time—be the pure flush fluid contained in the flush fluid connection 7, thereby reducing the risk that the fluid in the inner cavity 5 gets into contact with the inner wall of the reactor body 2. The buffer volume also helps to delay and prevent diffusion of unwanted contaminants from inner cavity 5 into outer cavity 6. The volume of the flush fluid connection 7 can be chosen such that fast equalization of the pressure of the inner cavity 5 and the pressure of the outer cavity 6 can be achieved. It is generally preferred to have long flush fluid connection 7 with a narrow cross section as this will provide a more efficient flush of the fluid connection 7 and minimize unwanted diffusion of contaminants, but the invention is not limited to such configuration of the flush fluid connection 7.

It is to be emphasised that although the figures and description only refers to a single flush fluid connection 7, a number of flush fluid connections 7 may be provided. Similarly, the various inlet and outlets may comprise a plurality.

As shown in FIG. 1, the flush fluid enters into the outer cavity 6 and flows through the outer cavity 6 and into the inner cavity 5 via the flush fluid connection 7. A flush fluid inlet 8 is arranged to feed flush fluid into the outer cavity 6, which flush fluid inlet 8 preferably is arranged at lower position of the reactor body 2.

The flush fluid is fed into the outer cavity 6 at a pressure level only slightly elevated relative to the pressure in the inner cavity 5 during oxidation. By this, the pressure acting on the enclosure can be reduced significantly resulting in lowering the requirements as to mechanical strength of the enclosure 4.

Further, as the inner surface of the reactor body 2 is not contacted by the contaminated aqueous fluid to be treated, the material of the reactor body 2 can be selected essentially without having to take into consideration the rather harsh chemical conditions present during oxidation or the aqueous fluid in general.

On the other hand, the inner surface of the enclosure 4 is exposed to the chemical conditions of the aqueous fluid and oxidation reactions, but as high mechanical strength of the enclosure is not necessitated, the amount of material which should at least for some time withstand the chemical and oxidation conditions can be lowered.

It may also be advantageous to enhance the heat transfer capability of flush fluid connection 7 by shaping the connection for example as a tubular helix similar to treated fluid output connection 9 as shown in FIG. 1, or by simply adding heat conducting fins on the outer surface of flush fluid connection 7. Similarly, the heat transfer capability of enclosure 4 can also be improved by adding more heat transfer area e.g. in the form of heat conducting fins to the outer and/or inner surfaces of the enclosure tubular wall section 16.

As detailed above, the oxidation takes place inside the inner cavity 5 and in order to allow the treated fluid to leave the reactor, a treated fluid output connection 9 is provided. This treated fluid output connection has an inlet 10 arranged at a second vertical height h₂ inside the inner cavity 3 and an outlet 11 arranged at the outside of the reactor body 2. It is noted that the second vertical height h₂ preferably is larger than first vertical height h₁ and the treated fluid output connection 9 extends from its inlet 10 downwardly towards the lower end of the reactor. Thus, treated fluid enters the treated fluid output connection 9 at a position elevated from the bottom of the reactors and flows downwardly towards and out through the outlet 11.

The aqueous fluid is introduced into the inner cavity 5 through an aqueous fluid inlet connection 12 arranged at the lower end of the reactor body for inletting into the inner cavity 5 the aqueous fluid to be brought into an elevated pressure and temperature.

An oxidizing may according to preferred embodiment comprise the following.

Initially, the outer and inner cavity 6, 5 are filled with flush water by introducing flush water into the outer cavity through the flush fluid inlet 8. When the inner and outer cavities 5, 6 are filled with water, the pump 19 (or another pump) increases the pressure to a preselected pressure level. The pressurising may be provided by a pressure regulator valve 21 arranged at the outlet 11. Such a pressure regulator may be set to be closed until a preselected backpressure is obtained where after the regulator valve 21 opens for flow. Should the pressure drop below the preselected pressure, the regulator valve 21 closes. During this filling or when the pressure regulator 21 opens, the temperature inside the reactor 2 may be increased to the desired operation temperature before the aqueous fluid to be treated is inlet into the inner cavity 5.

It is noted that while the oxidizing most often is an exothermic process providing sufficient energy to heat incoming aqueous fluid whereby the oxidizing process is self-sustainable, the heating during the start-up phase most often is provided by transferring heat into the fluid contained in the reactor. Further, when temperature increases while pressure regulating valve 21 is closed then the pressure may also increase, although the primary means (one or more pumps) to increase the pressure in the reactor is achieved by using one or more pumps in connection with raising the set pressure of pressure regulating valve 21.

When the pressure and temperature has reached a level sufficient for oxidizing the start-up phase may be said to have ended and infeed of aqueous fluid through the inlet connection 12 is provided whereby the oxidization commences.

During the oxidization, the aqueous fluid is typically continuously introduced into the inner cavity 5 and flush fluid is continuously introduced into the outer cavity 6. The pressure at which the flush fluid is introduced is slightly larger to provide a flow of flush fluid into the inner cavity 5. Non-limiting examples on slightly larger pressure may be 0.1 bar or 1.0 bar larger than the pressure inside the inner cavity 5 to prevent the aqueous fluid to “back flow” into the outer cavity 6 through the flush fluid connection 7, and to assure that the flush fluid indeed enters into the inner cavity 6. Further, the level of pressure difference between the inner and outer cavity 5, 6, is typically selected to minimize the pressure forces acting on the enclosure 4 while still preventing back flow of fluid from the inner cavity 5 and into the outer cavity 6, and the pressure difference may typically be determined by experiments in combination with calculation of the stresses induced in the enclosure 4 to avoid damage. It is noted that even for zero pressure difference, no backflow will be present and that such zero pressure difference is considered within the scope of the invention.

By having such a flow of the flush fluid that flows from the outer cavity 6 and into the inner cavity 5, the risk of the aqueous fluid entering the outer cavity 6 is substantially reduced and even avoided, thereby avoiding or at least reducing the possibility of any corrosive species contained in the inner cavity 5 getting into contact with the inner surface of the reactor 2.

The flush fluid connection 7 has purposely been provided with a length to provide what may be considered a buffer volume of flush fluid being the amount of flush fluid contained in the flush fluid connection 7. Such a buffer volume may come into action e.g. to account for pressure fluctuations where the pressure in the outer cavity 6 occasionally should be smaller than the pressure in the inner cavity 5 which drives a flow in the direction from the inner cavity 5 towards the outer cavity 6. If this occurs, the fluid flowing through flush fluid connection 7 is the buffer volume, whereby the risk of introducing the corrosive fluid contained in the inner cavity 5 into the outer cavity 6. The buffer volume exists also to reduce the risk of general diffusion of contaminants from inner cavity 5 into outer cavity 6.

During oxidation, salts and/or other debris, sediments may be present or produced and these elements may settle at the bottom of the reactor. However, diverting element 13 acts as an extension of flush fluid connection 7 and increases the buffer volume of flush water, further reducing the risk of contaminants entering outer cavity 6. Due to the flushing action of the flush water any contaminants that may enter diverting element 13 may at least to some extent be carried with the flush fluid due to the flushing action. However, in the case where the outlet of diverting element 13 is positioned at the top of the reactor that is running with supercritical water, the amount of salts and contaminants that may enter flush fluid connection 7 are greatly minimized. The flushing water mixes with the aqueous fluid in or at the outlet of diverting element 13 and this mixture of aqueous fluid, flush water and oxidation products, and other elements leaves the reactor through the treated fluid output connection 9.

As the inlet 10 of the treated fluid output connection is positioned at a higher position than the aqueous fluid inlet connection, the flow of the aqueous fluid—when considered as a plug flow—will flow from the bottom toward the upper end of the reactor, and the outflow from the reactor will be from the upper end towards the lower end. A vertical temperature gradient is typically prevailing in the fluid inside the inner cavity 5 having a lowest temperature at the bottom of the reactor. Accordingly, an oxidation zone, in which oxidation occur may be present vertically above a heating zone where the aqueous fluid is heated up. The heating of the aqueous fluid may at least be assisted by the downwardly flow of aqueous fluid inside the treated fluid output connection 10 by heat conduction through the treated fluid output connection 10 to the aqueous fluid surrounding the connection 10. Alternatively, or in combination, heating elements may be provided to heat the fluid inside the reactor 1.

In some preferred embodiments, the reactor 1 may have a height between 10 and 2 metres, such as between 8 and 4 metres. In some preferred embodiments, the reactor has a height around 6 metres. Preferably the reactor is configured to process between 100-700 litres per hour, such as process between 200 and 500 litres per hour.

The organics to be oxidized may essentially be any oxidizable matter, and preferred organics includes pesticides, oils, PFAS and the like.

As presented herein, an advantage of preferred embodiment is that the rather corrosive fluid contained in inner cavity 5 may be prevented from contacting the inner surface of the reactor body 2. Thereby the reactor body 2 can be manufactured from a relative in-expensive material that does not have to withstand chemical corrosion. However, the enclosure 4 which is contacted by the fluid in the inner cavity 5 should be manufactured from a material being able to withstand e.g. a corrosive action at least for a certain time period before corrosion fully penetrates enclosure 4. Such a time period may be months or even years. Furthermore, as the pressure difference across the enclosure is small, the wall thickness of the enclosure may be small whereby less material is needed to manufacture the enclosure, which may render the enclosure 4 a relative cheap component to replace. Non-limiting examples on the wall thickness of the enclosure is between 0.5 mm and 7.0 mm, such as between 1.0 mm and 5.0 mm.

While it is within the scope of the present invention to provide a certain permeability to the enclosure 4—which will provide a flow of flush fluid into the inner cavity 5 through e.g. pores—the enclosure 4 is in preferred embodiments made from a fluid impermeable material such as a metal alloy. Such impermeability will typically allow for a greater possibility to control the flow of flush fluid into the inner cavity through the flush fluid connection and create a buffer volume.

In many preferred embodiments, the enclosure 4 is releasably arranged within the reactor body 2. This refers in general to the situation where the reactor can be disassembled to gain access to the enclosure 4 to remove the enclosure 4 from the reactor 1. Such a removal depends on the way the enclosure is mounted in reactor 1, and in some preferred embodiments, the bottom of the enclosure 4 is locked into position by a suitable locking mechanism. Alternatively, the enclosure 4 may be fixedly mounted such as by welding whereby a material removal process is needed to remove the enclosure 4.

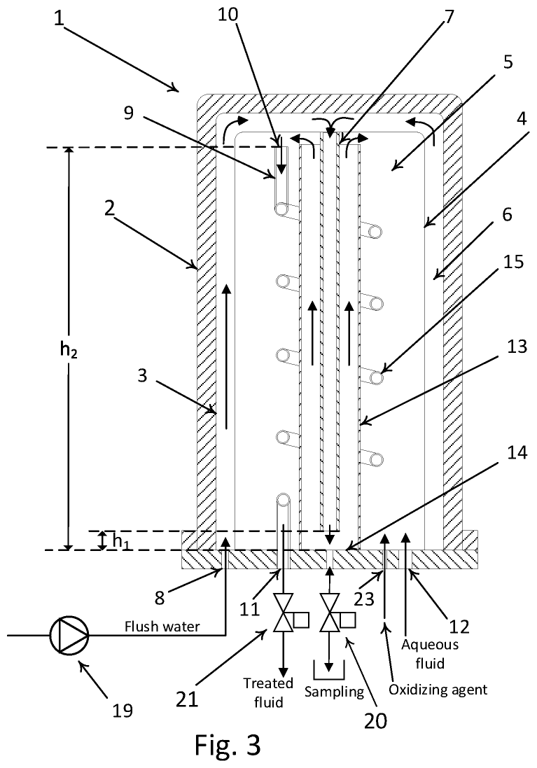

Reference is made to FIG. 2 showing a reactor according to preferred embodiments in an exploded 3-dimensional view. To render the figure clearer, some of the elements otherwise presented in FIGS. 1 and 3 have been left out as well as thickness are shown as being zero.

As illustrated in FIG. 2, the enclosure comprises an elongate tubular wall section 16 extending with its longitudinal direction parallel or substantial parallel to gravity. Tubular is not limited to cylindrical although this shape is preferred in some embodiments. In FIG. 2, gravity is directed downward and the orientation shown in FIG. 2 is a typical orientation during use of the reactor 1.

The elongate tubular wall section 16 is closed at an upper end by a top-member 17 from which the flush fluid connection 7 extends downwardly. The top member 17 may be a separate member welded or otherwise connected to the tubular wall 16. Alternatively, the top member 17 may be formed during manufacturing of the enclosure, e.g. by deep-drawing (in case of metals) to form the top member 17.

The tubular wall 16 has in some embodiments an open-end which is fluidically sealed against the reactor body 2 at the lower end of the reactor body 2. In addition to the above, this connection may be a welding or other connection which may provide a fluidic seal between the tubular wall 16 and the bottom of the reactor 2. The fluidic seal is typically to allow for a pressure difference between inner and outer cavities 5, 6 and assure that all flow between said cavities goes through the flush fluid connection 7.

Alternatively to sealing the tubular wall 16 against the reactor body, the enclosure 4 may be provided with a bottom member closing the elongate tubular wall section 16 at a lower end thereof. In such embodiments sealing of the various connection into/out from the inner cavity 5 may be needed to prevent e.g. leakage of flush fluid through into the inner cavity 5 along the bottom member of the enclosure. 4.

Reference is made to FIG. 3 illustrating another embodiment according to the invention. The embodiment shown in FIG. 3 has some similarities with the embodiment shown in FIG. 1 although the embodiment of FIG. 3 comprises a tubular fluid diverting element 13. The fluid diverting element 13 is arranged inside the inner cavity 5 with the flush fluid connection 7 extending at least partly internally in the tubular fluid diverting element 13. The flush fluid connection 7 and the fluid diverting element 13 may be co-axially arranged, although other arrangements may be used.

The inner dimension of the tubular fluid diverting element 13 is larger than an outer dimension of the flush fluid connection 7 to accommodate at least a section of the flush fluid connection 7 and to provide a flow passage in between at least a section of an outer surface of the flush fluid connection 7 and at least a section of an inner surface of fluid diverting element 13.

A lower end 14 of the tubular fluid diverting element 13 is positioned at the lower end of the reactor body 2. The fluidically closing of the fluid diverting element 13 may e.g. be provided by closing the lower end of the tubular fluid diverting element 13 or sealing the fluid diverting element 13 to the bottom of the reactor or—when the enclosure comprises a bottom element-to the bottom element of the enclosure 4.

An upper end of the tubular fluid diverting element 13 is arranged at distance from the inner upper end of the enclosure to provide a fluid passage between the upper end of the tubular fluid diverting element 13 and this inner upper end.

By use of such a fluid diverting element 13, the incoming flush fluid leaving the flush fluid connection 7 at a lower end thereof is forced to flow upwardly in the flow passage between the flush fluid connection 7 and the fluid diverting element 13 as illustrated in FIG. 3. The fluid diverting element 13 inter alia increases the buffer volume disclosed above in relation to the buffer volume of the flush fluid connection, by an amount at least comparable with the volume in between the inner surface of the fluid diverting element and the outer surface of the flush fluid connection. The fluid diverting element 13 also increases the meandering of the connection between the inner and outer cavities 5, 6, which may further reduce the risk of the rather corrosive fluid diffusing into the outer cavity 6. In addition, fluid diverting element 13 also provides heat exchange means between the flush fluid and the incoming aqueous fluid.

The tubular fluid diverting element may be provided with some permeability. However, in other preferred embodiments, tubular fluid diverting element is made from a fluid impermeable material, preferably being a metal alloy.

To enhance heat transfer capability, diverting element 13 may be formed e.g. as a tubular helix similar to treated fluid output connection 9 shown in FIG. 1, or by adding heat conducting fins on the outer and/or inner surfaces of diverting element 13 to increase the heat transfer area.

As mentioned, a temperature gradient between top and bottom of reactor typically prevails inside the reactor body where the highest temperature typically is found at the upper region of the reactor. It is often energy economical to transfer heat from the fluid at the upper region of the reactor to the colder fluid at the lower region of the reactor as this may render external heating obsolete or at least reduce the need for external heating. This is in the embodiments illustrated in FIGS. 1 and 3 provided by at least a section of the treated fluid output connection 9 is provided with a heat exchanger 15. It is noted that a heat exchanger in this connection preferably refers to a device increasing the heat flux relative to the heat flux provided by a straight tube extending downwardly inside the inner cavity 5.

In the preferred embodiments of FIGS. 1 and 3, the heat exchanger 15 is provided by at least a section of the treated fluid output connection 9 being coiled, such as helically coiled. The pitch in between neighbouring coils is preferably made larger than an outer dimension of the coils to allow for fluid passage in between coils. Alternatively, or in combination, the treated fluid out connection 9 may be provided with heat fins or the like increasing the area through which heat flux occurs.

The coils of the coiled section preferably encompass at least a section of the flush fluid connection 7. In embodiments, comprising a tubular fluid diverting element, the coils preferably encompass at least a section of the fluid diverting element 13. However, departure from such coiling around the flush fluid connection 7 or the tubular fluid diverting element 13 is considered to be within the scope of the present invention. The coils are mainly provided to heat up incoming aqueous fluid with the outgoing treated fluid, though it may also heat up the incoming flush fluid.

As detailed herein, it may be an advantage to be able to heat the fluid contained in the inner cavity 5, typically during start-up of the oxidation process or in case the oxidation reaction does not produce sufficient heat to fuel the oxidation. To this, the reactor may comprise one or more heating elements, such as electrical heating elements, arranged to provide heat to fluid inside the reactor cavity 3. There are different options available as to where to locate such heating elements and in preferred embodiments, the heating elements may be arranged on an outside surface of the reactor body 2 and/or internally in the inner cavity 5. In some embodiments, temperature sensors are provided to measure the temperature profile of the reactor and provide temperature feedback to the heating elements.

To introduce the flush fluid, the reactor typically comprises a pump 19 which is configured to feed flush fluid through the flush fluid inlet 8. It is noted that the pump 19 is typically a separate element located at distance from the reactor 2 and being connected to the flush water inlet 8 by a pipe. The pump 19 provides a pressure being larger than the pressure in the inner cavity during use of the reactor for water oxidation. The larger pressure takes into account flow resistance in the passage from the flush fluid inlet 8 to the inner cavity 5 and to provide a flow into the inner cavity 5 of flush fluid. While such a pressure may be determined empirically or experimentally, it may also be controlled by a flow measuring device measuring whether or not flow is in the direction towards the inner cavity 5 and controlling the pressure to control the flow of flush fluid.

It is often desirable to be able to control the pressure inside the reactor, e.g. to be larger than a preselected pressure. The preselected pressure is typically determined with regards to the expected oxidation processes. It is noted that it is mainly the temperature that initiates the oxidation reaction and that the increased pressure accelerates the reactions. To accomplish this, the reactor 1 may be equipped with a pressure regulating valve 21 arranged to control the flow of treated fluid out of the reactor through the outlet 11. The pressure regulating valve is configured to allow flow when a preselected pressure differential across said pressure regulating valve 21 exceeds a preselected threshold. By this, the pressure inside the reactor may stay substantially constant.

For some oxidation process, there is sufficient oxygen present in the aqueous fluid to allow for the oxidation reaction(s) to proceed. However, other oxidation processes may require an excess of oxygen relatively to the amount present in the aqueous fluid. To provide such an excess of oxygen, preferred embodiments of the reactor have an oxidizing agent inlet 23 configured to introduce an oxidizing agent such as atmospheric air, hydrogen peroxide, nitric acid and/or oxygen into the inner cavity 5. In combination herewith or as an alternative, the oxidizing agent may be mixed into the aqueous fluid, typically prior to inlet of the aqueous fluid into the reactor.

It may be advantageous to be able to take out a sample of the fluid contained in the inner cavity 5 e.g. for chemical analysis. To this, preferred embodiments, comprises a sample outlet 20 being arranged and configured to take out a fluid sample from the inner cavity 5 and/or outer cavity 6, such as to sample the flush fluid entering into the inner cavity 5 and/or the aqueous fluid in the inner cavity 5. In the embodiments shown in FIG. 3 the sample outlet 20 is located right below the outlet of the flush fluid connection 7. In the embodiment of FIG. 3, the sample will typically—if no back flow of flush water is established—essentially only contain flush water. If contaminants are detected from said sample then this could indicate backflow or contamination of outer cavity 6. If additional sampling of process fluid is to be obtained then a sample outlet is arranged at the position desired to be monitored. The sample outlet 20 comprises as illustrated a closable valve mechanism.

Although the present description herein has been focussed toward disclosing the enclosure 4 as a replaceable part, one or more, such all of the other parts housed in the inner cavity 5 may preferably be considered as replaceable parts. That is, in preferred embodiments, the flush fluid connection 7, the tubular fluid diverting element 13, the treated fluid output connection 9 and/or the heat exchanger 15 may be replaceable parts.

The use of the reactor to oxidize may typically comprise the actions of introducing an aqueous fluid containing organic and/or inorganic material to be oxidized into the inner cavity through the aqueous fluid inlet connection 12, introducing an oxidizing agent either through aqueous fluid inlet connection 12 and/or a dedicated oxidizing agent inlet connection 23, introducing a flush fluid, preferably being water such as demineralized water, into outer cavity 6 through the flush fluid inlet 8 and maintaining a pressure and a temperature inside the inner cavity sufficient to provide at least some oxidation of said organic and/or inorganic material. Maintaining of the pressure and temperature may be provided in numerous ways and in some embodiments this maintaining may be summarized by controlling a flow rate of treated fluid in combination with controlling a back 5 pressure at the treated fluid output connection 11. It is noted, that if the aqueous fluid contains an amount oxidizing agent sufficient for the oxidization process, the need for a separate introduction of oxidizing agent may not be present.

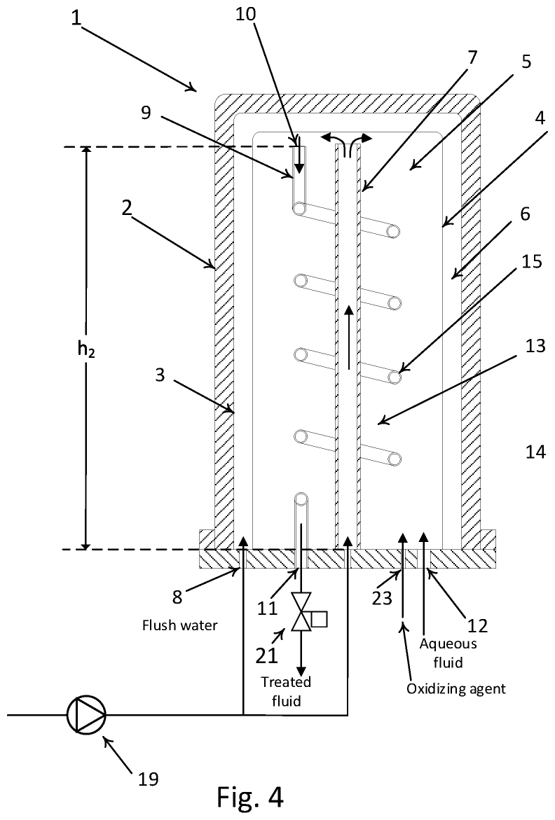

Reference is made to FIG. 4 schematically illustrating a further embodiment according to the invention. The embodiment illustrated in FIG. 4 has many similarities with the other embodiments disclosed herein, although the flush fluid connection 7 proceed in different manner. As illustrated the flush fluid connection 7 extends upwardly from a bottom of reactor 1 and into the inner cavity 5. The flush fluid connection 7 is in the illustrated embodiment fluidicly connected to the flush fluid inlet 8 to feed flush fluid into said flush fluid connection 7. It is noted that fluidicly connected to the flush fluid connection is to be interpreted broadly in the sense that there is a fluidic connection that feeds flush fluid into the outer cavity 6 and into the flush fluid connection 7 and that the pressures of the flush fluid being fed into the outer cavity and the pressure of fluid fed into flush connection are essential the same. This may be accomplished by a direct fluid connection from the flush fluid inlet 8 and to the flush fluid connection 7, or by separate connection branched off at position in between the pump 19 and the inlet to the flush fluid connection 7.

The embodiment of FIG. 4 has inter alia the advantageous of that during stable operation there will typically be no or at least limited flow in outer cavity 6 which inter alia enhances heat transfer. Further, should a crack in the enclosure 4 will result in a continuous positive flow through the flush fluid inlet connection 8 which can be detected immediately by a flow transmitter. In addition, the embodiment of FIG. 4 may be relatively cheaper to manufacture and easy to install

During maintaining of the pressure and temperature, the oxidizing agent may be introduced in a controlled manner with regards to the amount. As the amount of oxidizing agent at least to some extent is responsible for the amount of heat generated by oxidizing, the temperature and pressure may at least be partially controlled by controlling the amount of oxidizing agent. In addition, some embodiments include heating elements, and such heating elements can also be used to at least assist in controlling the temperature and pressure by controlling heat flux from the heating elements.

In some embodiments the oxidation occurs at subcritical and/or supercritical conditions. This includes that the reactor may be operated in pure subcritical condition or a combination of subcritical and supercritical conditions.

In some embodiments, the oxidation and/or gasification occur(s) at subcritical and/or supercritical conditions. This includes that the reactor may be operated in pure subcritical condition, pure supercritical condition or a combination of subcritical and supercritical conditions.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### Itemized List of Preferred Embodiments

Item 1. An aqueous fluid oxidation reactor (1) adapted to contain inside the reactor (1) an aqueous fluid at elevated pressure and temperature during which an oxidation occurs, said fluid comprising organic and/or inorganic material, wherein the reactor (1) comprising
a reactor body (2) in the form of an elongate tubular element arranged, during use, with its longitudinal extension parallel to or substantially parallel to gravity, the reactor body (2) being closed at its upper and lower ends thereby defining a reactor cavity (3) inside the reactor body (2);
an enclosure (4) extending from said lower end toward said upper end, said enclosure (4) divides the reactor cavity (3) into an inner cavity (5) inside the enclosure (4) and an outer cavity (6) outside the enclosure (4),
a flush fluid inlet (8) arranged to feed flush fluid into the outer cavity (6),
a flush fluid connection (7) extending
   downwardly from the outer cavity (6) and into the inner cavity (5) from a position at an upper end of said enclosure (4) and to first vertical height (h₁), said vertical height being larger than zero and/or
   upwardly from a bottom of said reactor (1) and into the inner cavity (5) and being fluidicly connected to said flush fluid inlet (8) to feed flush fluid into said flush fluid connection;
   a treated fluid output connection (9) having an inlet (10) arranged at a second vertical height (h₂) inside said inner cavity (3), and having an outlet (11) arranged at the outside of the reactor body (2), said second vertical height (h₂) being larger than said first vertical height (h₁) and said treated fluid output connection (9) extends from its inlet (10) downwardly towards the lower end of the reactor;
an aqueous fluid inlet connection (12) arranged at the lower end of the reactor body for inletting into the inner cavity (5) the aqueous fluid and oxidizing agent to be brought into an elevated pressure and temperature.

Item 2. A reactor according to item 1, wherein a wall thickness of the (4) enclosure is between 0.5 mm and 7.0 mm, such as between 1.0 mm and 5.0 mm.

Item 3. A reactor according to item 1 or 2, wherein the enclosure (4) is made from a fluid impermeable material, preferably being a metal alloy.

Item 4. A reactor according to any one of the preceding items, wherein the enclosure (4) is releasable arranged within the reactor body (2).

Item 5. A reactor according to any one of the preceding items, wherein the enclosure comprising
an elongate tubular wall section (16) extending with its longitudinal direction parallel or substantial parallel to gravity, said elongate tubular wall section (16) being closed at an upper end by a top-member (17) from which said flush fluid connection (7) extends downwardly, said elongate tubular wall section (16) either
   has an open-end which is fluidically sealed against the reactor body (2) at said lower end of the reactor body (2), or
   has a bottom member closing the elongate tubular wall section (16) at a lower end thereof.

Item 6. A reactor according to any one of items 1-5 further comprising a tubular fluid diverting element (13) arranged inside the inner cavity (5) with the flush fluid connection (7) extending at least partly internally in the tubular fluid diverting element (13), wherein
an inner dimension of the tubular fluid diverting element (13) is larger than an outer dimension of the flush fluid connection (7) to provide a flow passage in between at least a section of an outer surface of the flush fluid connection (7) and at least a section of an inner surface of the fluid diverting element (13),
a lower (14) end of the tubular fluid diverting element (13) is positioned and fluidically sealed at the lower end of the reactor body (2), and
an upper end of the tubular fluid diverting element (13) is arranged at distance from the inner upper end of the enclosure to provide a fluid passage between the upper end of the tubular fluid diverting element (13) and said inner upper end.

Item 7. A reactor according to any one of items 1-5, further comprising a tubular fluid diverting element (13) arranged inside the inner cavity (5) with the flush fluid connection (7) extending at least partly internally in the tubular fluid diverting element (13), where tubular fluid diverting element (13) is a direct extension or continuation of flush fluid connection (7).

Item 8. A reactor according to item, wherein the tubular fluid diverting element (13) is made from a fluid impermeable material, preferably being a metal alloy.

Item 9. A reactor according to any one of the preceding items, wherein at least a section of the treated fluid output connection (9) is provided with a heat exchanger (15) and/or, wherein at least a section of flush fluid connection (7) is configured as a heat exchanger and/or, wherein at least a section of fluid diverting element (13) is configured as a heat exchanger.

Item 10. A reactor according to item 9, wherein the heat exchanger (15) is provided by at least a section of the treated fluid output connection (9) being coiled, such as helically coiled, preferably with a pitch in between neighbouring coils being larger than an outer dimension of said coils to allow for fluid passage in between said coils.

Item 11. A reactor according to item 10, wherein coils of the coiled section encompass at least a section of the flush fluid connection (7) and when dependant on claim 6 or 7 coils of the coiled section encompass at least a section of the fluid diverting element (13).

Item 12. A reactor according to any one of the preceding items, further comprising one or more heating elements, such as electrical heating elements, arranged to provide heat to fluid inside the reactor cavity (3), such as being arranged on an outside surface of the reactor body (2) and/or internally inside the inner cavity (5).

Item 13. A reactor according to any one of the preceding items, further comprising a pump (19) configured to feed flush fluid through the flush fluid inlet (8) at a pressure being larger than the pressure in the inner cavity during use of the reactor for water oxidation.

Item 14. A reactor according to any one of the preceding items, further comprise a pressure regulating valve (21) arranged to control the flow of treated fluid out of the reactor through the outlet (11), wherein said pressure regulating valve is configured to allow flow when a preselected pressure differential across said pressure regulating valve (21) exceeds a preselected threshold.

Item 15. A reactor according to any one of the preceding items, further comprising an oxidizing agent inlet (23) configured to introduce an oxidizing agent such as atmospheric air, hydrogen peroxide, nitric acid and/or oxygen into the inner cavity (5).

Item 16. A reactor according any one of the preceding items further comprising an oxidizing agent inlet for introducing and mixing an oxidizing agent such as atmospheric air and/or oxygen into the aqueous fluid prior to feeding the aqueous fluid into the reactor.

Item 17. A reactor according to any one of the preceding items further comprising a sample outlet (20) being arranged and configure to take out a fluid sample from the inner cavity (5) and/or outer cavity 6.

Item 18. A method of carrying out water oxidation, the method utilizes a reactor according to any one of the preceding claims and comprising
introducing an aqueous fluid containing organic and/or inorganic material to be oxidized into the inner cavity through the aqueous fluid inlet connection (12),
preferably, introducing an oxidizing agent as a separate inlet and/or mixed into the aqueous fluid;
introducing a flush fluid, preferably being water such as demineralized water, into outer cavity (6) through the flush fluid inlet (8),
maintaining a pressure and a temperature inside the inner cavity (6) sufficient to facilitate at least some oxidation of said organic and/or inorganic material, wherein said maintenance of said pressure and temperature is provided by controlling a flow rate of aqueous fluid in combination with controlling a back pressure at the treated fluid output connection (9).

Item 19. A method according to item 18, wherein during maintaining of said pressure and temperature, said oxidizing agent is introduced in a controlled manner with regards to the amount, and if heating elements are present a heat flux from said heating elements is also controlled.

Item 20. A method according to item 18 or item 19, wherein the oxidation occurs at subcritical and/or supercritical conditions.

### LIST OF REFERENCE SYMBOLS USED

1 Reactor
2 Reactor body
3 Reactor cavity
4 Enclosure
5 Inner cavity
6 Outer cavity
7 Flush fluid connection
8 Flush fluid inlet
9 Treated fluid output connection
10 Inlet (of treated fluid output connection)
11 Outlet (of treated fluid output connection)
12 Aqueous fluid inlet connection
13 Tubular fluid diverting element
14 Lower end (of tubular fluid diverting element)
15 Heat exchanger
16 Elongate tubular wall section (of enclosure)
17 Top-member (of enclosure)
18 Bottom-member (of reactor body)
19 Pump
20 Sample outlet
21 Pressure regulating valve
22 Top-member (of reactor body)
23 Oxidizing agent inlet
h₁ First vertical height
h₂ Second vertical height

1-23. (canceled)

24. An aqueous fluid reactor adapted to contain inside the reactor an aqueous fluid at elevated pressure and temperature, said fluid comprising organic and/or inorganic material, the reactor comprising:
a reactor body in the form of an elongate tubular element having a longitudinal extension and the reactor body arranged, during use, with its longitudinal extension parallel to or substantially parallel to gravity, the reactor body being closed at an upper end and at a lower end thereby defining a reactor cavity inside the reactor body;
an enclosure extending from said lower end toward said upper end, said enclosure dividing the reactor cavity into an inner cavity inside the enclosure and an outer cavity outside the enclosure,
a flush fluid inlet arranged to feed flush fluid into the outer cavity,
a flush fluid connection, the flush fluid connection
(1) extending downwardly from the outer cavity and into the inner cavity from a position at an upper end of said enclosure and to a first vertical height, said vertical height being larger than zero, and/or
(2) extending upwardly from a bottom of said reactor and into the inner cavity and being fluidly connected to a flush fluid inlet to feed flush fluid into said flush fluid connection;
a treated fluid output connection (i) having an inlet arranged at a second vertical height inside said inner cavity, and (ii) having an outlet arranged outside of the reactor body, and said treated fluid output connection extends from its inlet downwardly towards the lower end of the reactor;
an aqueous fluid inlet connection arranged at the lower end of the reactor body for inletting into the inner cavity the aqueous fluid to be brought into an elevated pressure and temperature.

25. A reactor according to claim 24, wherein said aqueous fluid inlet connection is additionally arranged to inlet into the inner cavity an oxidizing agent to be brought into an elevated pressure and temperature.

26. A reactor according to claim 24, wherein the reactor is adapted to contain inside the reactor said aqueous fluid at elevated pressure and temperature during which an oxidation occurs.

27. A reactor according to claim 24, wherein the reactor is adapted to contain inside the reactor said aqueous fluid at elevated pressure and temperature during which a gasification occurs.

28. A reactor according to claim 24, wherein the enclosure comprises a wall having a wall thickness of between 0.5 mm and 7.0 mm.

29. A reactor according to claim 24, wherein the enclosure comprises a fluid impermeable material.

30. A reactor according to claim 24, wherein the enclosure is releasably arranged within the reactor body.

31. A reactor according to claim 24, wherein the enclosure comprises
an elongate tubular wall section extending in an longitudinal direction parallel or substantial parallel to gravity, said elongate tubular wall section being closed at an upper end by a top-member from which said flush fluid connection extends downwardly, said elongate tubular wall section
(1) having an open-end which is fluidly sealed against the reactor body at said lower end of the reactor body, or
(2) having a bottom member closing the elongate tubular wall section at a lower end thereof.

32. A reactor according to claim 24, further comprising a tubular fluid diverting element arranged inside the inner cavity with the flush fluid connection extending at least partly internally in the tubular fluid diverting element, wherein
an inner dimension of the tubular fluid diverting element is larger than an outer dimension of the flush fluid connection so as to provide a flow passage in between at least a section of an outer surface of the flush fluid connection and at least a section of an inner surface of the fluid diverting element,
a lower end of the tubular fluid diverting element is positioned and fluidly sealed at the lower end of the reactor body, and
an upper end of the tubular fluid diverting element is arranged at distance from the upper end of the enclosure to provide a fluid passage between the upper end of the tubular fluid diverting element and said upper end of the enclosure.

33. A reactor according to claim 24, further comprising a tubular fluid diverting element arranged inside the inner cavity with the flush fluid connection extending at least partly internally in the tubular fluid diverting element, where tubular fluid diverting element is a direct extension or continuation of flush fluid connection.

34. A reactor according to claim 32, wherein the tubular fluid diverting element comprises a fluid impermeable material.

35. A reactor according to claim 33, wherein the tubular fluid diverting element comprises a fluid impermeable material.

36. A reactor according to claim 24, wherein any one or more of (1) at least a section of the treated fluid output connection is provided with a heat exchanger, (2) at least a section of flush fluid connection is configured as a heat exchanger, or (3) at least a section of fluid diverting element is configured as a heat exchanger.

37. A reactor according to claim 36, wherein the heat exchanger is provided by at least a section of the treated fluid output connection being coiled.

38. A reactor according to claim 37, wherein coils of the coiled section encompass at least a section of the flush fluid connection.

39. A reactor according to claim 38, wherein the enclosure comprises a fluid impermeable material, and wherein coils of the coiled section encompass at least a section of the fluid diverting element.

40. A reactor according to claim 38, wherein the enclosure is releasably arranged within the reactor body, and wherein coils of the coiled section encompass at least a section of the fluid diverting element.

41. A reactor according to claim 24, further comprising one or more heating elements arranged to provide heat to fluid inside the reactor cavity.

42. A reactor according to claim 24, further comprising a pump configured to feed flush fluid through the flush fluid inlet at a pressure being larger than a pressure in the inner cavity during use of the reactor for water oxidation.

43. A reactor according to claim 24, further comprise a pressure regulating valve arranged to control a flow of treated fluid out of the reactor through the outlet, wherein said pressure regulating valve is configured to allow flow when a preselected pressure differential across said pressure regulating valve exceeds a preselected threshold.

44. A reactor according to claim 24, further comprising an oxidizing agent inlet configured to introduce an oxidizing agent into the inner cavity.

45. A reactor according to claim 24, further comprising an oxidizing agent inlet for introducing and mixing an oxidizing agent into the aqueous fluid prior to feeding the aqueous fluid into the reactor.

46. A reactor according to claim 24, further comprising a sample outlet being arranged and configure to take out a fluid sample from at least one of the inner cavity or the outer cavity.

47. A method of carrying out water oxidation and/or gasification, the method comprising:
with a reactor according to claim 24,
introducing an aqueous fluid containing organic and/or inorganic material to be oxidized into the inner cavity through the aqueous fluid inlet connection;
introducing a flush fluid into outer cavity through the flush fluid inlet; and
maintaining a pressure and a temperature inside the inner cavity sufficient to facilitate at least some oxidation and/or gasification of said organic and/or inorganic material, wherein said maintaining said pressure and temperature is provided by controlling a flow rate of aqueous fluid in combination with controlling a back pressure at the treated fluid output connection.

48. A method according to claim 45, comprising introducing an oxidizing agent as a separate inlet and/or mixed into the aqueous fluid.

49. A method according to claim 45, wherein during maintaining of said pressure and temperature, an oxidizing agent is introduced in a controlled manner, and if heating elements are present a heat flux from said heating elements is also controlled.

50. A method according to claim 45, wherein oxidation occurs at subcritical and/or supercritical conditions.

51. A reactor according to claim 24, wherein (1) the flush fluid connection extends downwardly from the outer cavity and into the inner cavity from a position at an upper end of said enclosure and to a first vertical height, said vertical height being larger than zero, and (2) the second vertical height is larger than the first vertical height.
